(19) United States
(12) Patent Application Publication
(10) Pub. No.: US 2025/0065647 A1
(43) Pub. Date: Feb. 27, 2025

(54) LIQUID COATER, COATING METHOD, AND IMAGE FORMING SYSTEM

(71) Applicant: Keita Achi, KANAGAWA (JP)

(72) Inventor: Keita Achi, KANAGAWA (JP)

(73) Assignee: Ricoh Company, Ltd., Tokyo (JP)

(21) Appl. No.: 18/745,129

(22) Filed: Jun. 17, 2024

(30) Foreign Application Priority Data
Aug. 25, 2023 (JP) 2023-137278

(51) Int. Cl. B41J 11/00; B41J 13/076; B41J 29/377

(52) U.S. Cl. CPC B41J 11/0015; B41J 11/007; B41J 13/076; B41J 29/377

(57) ABSTRACT

A liquid coater includes: a coater to contact with a medium and coat, with a liquid, the medium conveyed to the coater in a conveyance direction; and a driver, to move the coater in a width direction intersecting the conveyance direction, the driver including: a slider slidable with the coater in the width direction; and a sensor feeler slidable with the slider in the width direction and including: two or more protrusions along the width direction; and a recess between the two or more protrusions in the width direction; and multiple feeler sensors arranged in the width direction and including: a first feeler sensor; and a second feeler sensor, separated from the first feeler sensor in the width direction, to detect the two or more protrusions and the recess of the sensor feeler; and circuitry configured to control a movement of the coater based on a combination of: a first sensor output that is an output from the first feeler sensor in response to a detection of the sensor feeler; and a second sensor output that is an output from the second feeler sensor in response to a detection of the sensor feeler.

### CROSS-REFERENCE TO RELATED APPLICATIONS

This patent application is based on and claims priority pursuant to 35 U.S.C. § 119(a) to Japanese Patent Application No. 2023-137278, filed on Aug. 25, 2023, in the Japan Patent Office, the entire disclosure of which is hereby incorporated by reference herein.

### BACKGROUND

### Technical Field

The present disclosure relates to a liquid coater, a coating method, and an image forming system.

### Related Art

A liquid coater coats a conveyed medium with a treatment liquid. A mechanism for coating the medium with the treatment liquid includes a roller mechanism that changes a contact position while rotating on the medium. With this mechanism, wear increases at part of the roller in contact with the medium, so that the part of the roller is different in the level of wear from the other part of the roller. Thus, the coating face for coating the medium with the treatment liquid is uneven, which inhibits the uniformity of coating with the treatment liquid from being maintained. Therefore, in order to reduce an increase in partial wear of the roller due to contact with the medium, coating with the treatment liquid is performed while the part of the roller in contact with the medium is moved. As a result, the durability of the roller is improved.

### SUMMARY

The present disclosure described herein provide a liquid coater including: a coater to contact with a medium and coat, with a liquid, the medium conveyed to the coater in a conveyance direction; and a driver, to move the coater in a width direction intersecting the conveyance direction, the driver including: a slider slidable with the coater in the width direction; and a sensor feeler slidable with the slider in the width direction and including: two or more protrusions along the width direction; and a recess between the two or more protrusions in the width direction; and multiple feeler sensors arranged in the width direction and including: a first feeler sensor; and a second feeler sensor, separated from the first feeler sensor in the width direction, to detect the two or more protrusions and the recess of the sensor feeler; and circuitry configured to control a movement of the coater based on a combination of: a first sensor output that is an output from the first feeler sensor in response to a detection of the sensor feeler; and a second sensor output that is an output from the second feeler sensor in response to a detection of the sensor feeler.

### BRIEF DESCRIPTIONS OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a configuration view of an exemplary embodiment of an image forming system according to the present disclosure;

FIG. 2 is a configuration view of an exemplary treatment liquid coater as an embodiment of a liquid coater according to the present disclosure;

FIG. 3 is a schematic view of an exemplary configuration of the treatment liquid coater;

FIG. 4 is a schematic view of an exemplary movement module included in the treatment liquid coater;

FIG. 5 is a schematic view of an exemplary positional detection mechanism included in the treatment liquid coater;

FIGS. 6A to 6C are tables of an exemplary sensing of a current position in the positional detection mechanism;

FIG. 7A is a schematic view of the exemplary positional detection mechanism included in the treatment liquid coater;

FIGS. 7B to 7D are each a schematic view of an exemplary positional detection mechanism included in the treatment liquid coater different from the positional detection mechanism in FIG. 7A;

FIG. 8 is an exemplary hardware configuration of a control block of the treatment liquid coater; and

FIG. 9 is a diagram illustrating an exemplary functional configuration of the control block of the treatment liquid coater.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Hereinafter, embodiments of a liquid coater, a method of controlling the liquid coater, and an image forming system according to the present disclosure will be described with reference to the accompanying drawings.

### Embodiment of Image Forming Apparatus

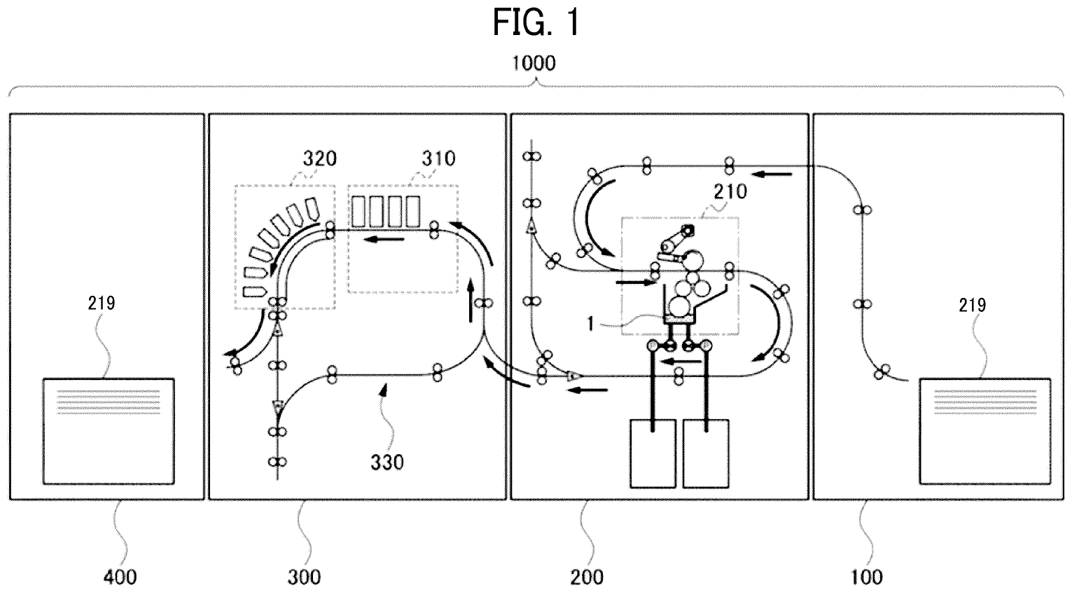

FIG. 1 is a schematic view of an image forming system 1000 according to an embodiment of the present disclosure. As illustrated in FIG. 1, the image forming system 1000 is a printing system including a feeder 100, a treatment liquid coater 200, a printer 300 as an image forming apparatus, and a medium ejector 400. Each unit as a constituent of the feeder 100, the treatment liquid coater 200, the printer 300, and the medium ejector 400 of the image forming system 1000 may be modularized or integrated.

The feeder 100 is a recording medium supply apparatus that stores a sheet 219 as a recording medium on which an image is to be formed and supplies the sheet 219 to the treatment liquid coater 200. The sheet 219 is, for example, sheet-like “cut paper” cut into a predetermined size. As the sheet 219, paper different from the cut paper can also be used.

The treatment liquid coater 200 corresponds to an embodiment of the liquid coater according to the present disclosure. The treatment liquid coater 200 coats an image forming face of the sheet 219 with a treatment liquid 207 having an effect of aggregating the ink discharged on the sheet 219 to prevent the back reflection. The component of the treatment liquid 207 is appropriately selected in consideration of, for example, the ink component or the material of the sheet 219. Note that the type of the treatment liquid is not limited, and thus the sheet 219 can be coated with a treatment liquid for various uses.

The printer 300 includes an image former 310 and a dryer 320. The image former 310 discharges ink droplets onto the sheet 219 coated with the treatment liquid in the treatment liquid coater 200 to form an image. The dryer 320 dries the treatment liquid 207 and the ink droplets attached to the sheet 219.

The printer 300 further includes a reverser 330 for printing on the front and back of the sheet 219. The reverser 330 has a function of reversing the sheet 219 and returning the sheet 219 from the dryer 320 to the image former 310. With this arrangement, after an image is formed by discharging the ink droplets onto the back face of the image forming face with an image previously formed thereon, can be performed processing in which the dryer 320 dries the face with the image newly formed thereon to have the respective images on the front and back face of the sheet 219. The sheet 219 subjected to the image formation by the printer 300 is ejected to the medium ejector 400.

The medium ejector 400 is an apparatus that accommodates the sheet 219 subjected to the image forming processing in the printer 300.

### Embodiment of Liquid Coater

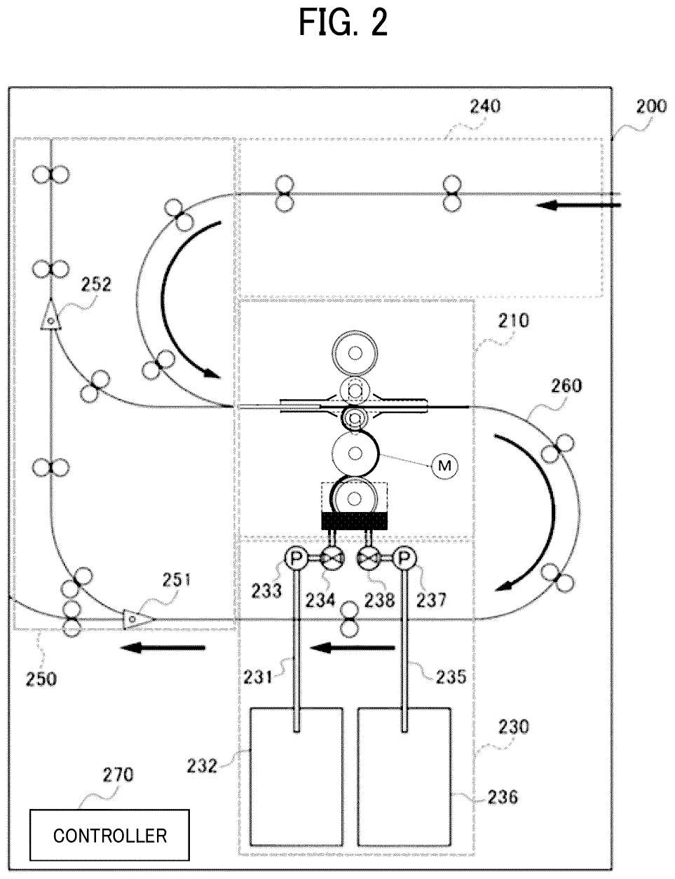

Next, an exemplary configuration of the treatment liquid coater 200 is illustrated in FIG. 2. As illustrated in FIG. 2, the treatment liquid coater 200 includes a liquid coating unit 210, a treatment liquid supply unit 230, a carry-in portion 240, a carry-out portion 250, a conveyance path 260, and a controller 270.

The treatment liquid supply unit 230 includes a supply tank 232 and a waste liquid tank 236. The supply tank 232 is connected to a liquid supply pan 208 through a supply pipe 231. The waste liquid tank 236 is connected to the liquid supply pan 208 through a drain pipe 235. A supply pump 233 and a supply valve 234 are disposed in the supply pipe 231. When the treatment liquid 207 stored in the liquid supply pan 208 falls below a predetermined level, the supply valve 234 is opened, the supply pump 233 is driven, and the treatment liquid 207 is supplied to the liquid supply pan 208. The predetermined level of the treatment liquid 207 is set so as to maintain a liquid level at which at least a drawing roller 201 can draw the treatment liquid 207. A drain pump 237 and a drain valve 238 are disposed in the drain pipe 235. By opening the drain valve 238 and driving the drain pump 237, the deteriorated treatment liquid 207 in the liquid supply pan 208 can be drained to the waste liquid tank 236.

The carry-in portion 240 is a portion where the sheet 219 conveyed from the feeder 100 is introduced into the treatment liquid coater 200. The carry-out portion 250 is a portion where the sheet 219 coated with the treatment liquid 207 by the liquid coating unit 210 is sent to the printer 300. The conveyance path 260 includes multiple conveyance rollers and multiple paper guides. The sheet 219 as a sheet-like medium ejected from the feeder 100 is carried into the treatment liquid coater 200 through the carry-in portion 240. The sheet 219 is conveyed through the conveyance path 260 to reach the liquid coating unit 210. The sheet 219 is coated with the treatment liquid 207. Thereafter, the sheet 219 is conveyed to the carry-out portion 250 through the conveyance path 260 and sent to the printer 300. A first bifurcating gate 251 and a second bifurcating gate 252 are each disposed in the conveyance path 260 in the carry-out portion 250 for switching the conveyance direction of the sheet 219.

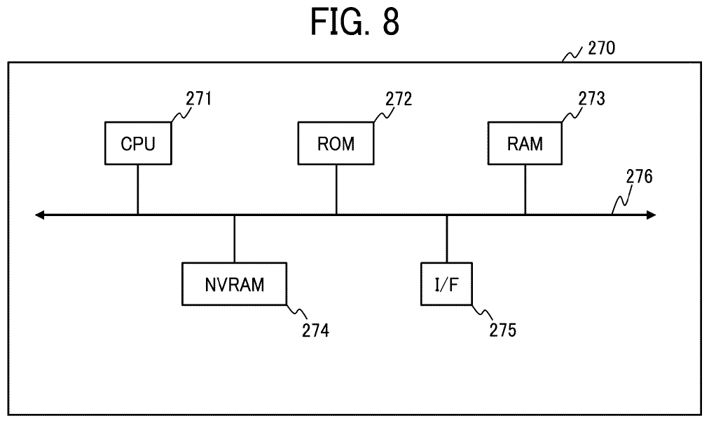

The controller 270 corresponds to a controller that controls the operation of the treatment liquid coater 200. FIG. 8 is an exemplary hardware configuration of the controller 270. As illustrated in FIG. 8, the controller 270 is an information processor including, for example, a central processing unit (CPU) 271, a read only memory (ROM) 272, a random access memory (RAM) 273, a non-volatile random access memory (NVRAM) 274 as a rewritable nonvolatile memory for holding data even while the power is off, an interface (I/F) 275, and a data bus 276 for cooperation among the CPU 271, the ROM 272, the RAM 273, the NVRAM 274, and the I/F 275. The controller 270 implements a processing function resulting from execution of a computer program.

The controller 270 is an electronic component that causes the CPU 271 to execute a control program recorded in the ROM 272 to control the operation of the operation mechanism included in the treatment liquid coater 200. The RAM 273 included in the controller 270 is used as a work area in the execution of the control program. The NVRAM 274 of the controller 270 stores various pieces of data to be used in treatment liquid coating control processing to be described later. That is, in the controller 270, the CPU 271 reads the control program stored in the ROM 272 and develops the control program in the storage area of the RAM 273, and the CPU 271 executes the control program while reading the various pieces of data stored in the NVRAM 274. The NVRAM 274 constitutes a storage unit that stores a coating amount data table and a coating amount correction data table to be described later.

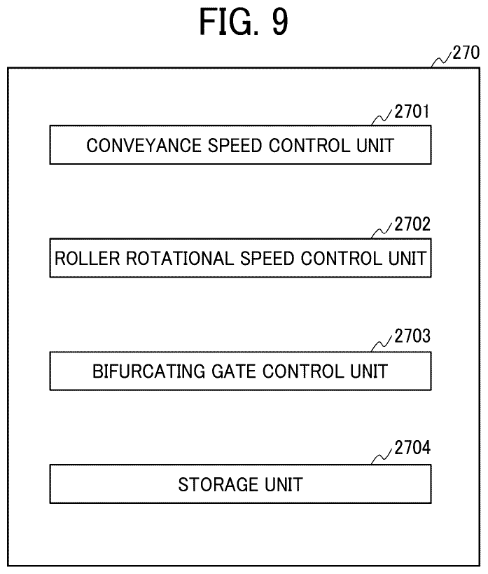

FIG. 9 is a diagram of functional blocks implemented by the execution of the control program in the controller 270. As illustrated in FIG. 9, the controller 270 includes a conveyance speed control unit 2701, a roller rotational speed control unit 2702, a bifurcating gate control unit 2703, and a storage unit 2704. The conveyance speed control unit 2701 controls the conveyance speed of the sheet 219. The roller rotational speed control unit 2702 controls the rotational speed of a coating roller 203. The bifurcating gate control unit 2703 causes the sheet 219 to be reversed for coating with the treatment liquid 207 on both the front and back faces for image formation on both the faces of the sheet 219. The storage unit 2704 stores, for example, parameters to be used by the control program.

In the controller 270 according to the present disclosure, the conveyance speed control unit 2701 controls the conveyance speed of the sheet 219 due to the operation of the coating roller 203 included in the liquid coating unit 210 (liquid coating conveyance speed), on the basis of the conveyance speed of the sheet 219 in the printer 300 (image formation conveyance speed). In this case, in the controller 270, the roller rotational speed control unit 2702 performs control such that the liquid coating conveyance speed is faster than the image formation conveyance speed. Specifically, the rotational speed of a driver that causes a roller drive motor 206 to rotate the coating roller 203 is controlled to be faster than the rotational speed of a driving source that defines the image formation conveyance speed. The rotational speed of the coating roller 203 is changed by this control to change the coating amount of the treatment liquid.

Therefore, the controller 270 performs control such that any change can be made to the liquid coating conveyance speed with the image formation conveyance speed constant. That is, the image formation conveyance speed is used as a reference and the amount of change in the liquid coating conveyance speed is controlled on the basis of the reference, so that any change is made to the liquid coating conveyance speed to change the coating amount of the treatment liquid. Further, in the controller 270, the bifurcating gate control unit 2703 controls the conveyance operation of the sheet 219 in the conveyance path 260 and the operation of switching between the first bifurcating gate 251 and the second bifurcating gate 252 in accordance with printing on the front of the sheet 219 or printing on the front and back of the sheet 219.

### Configuration of Coating Module

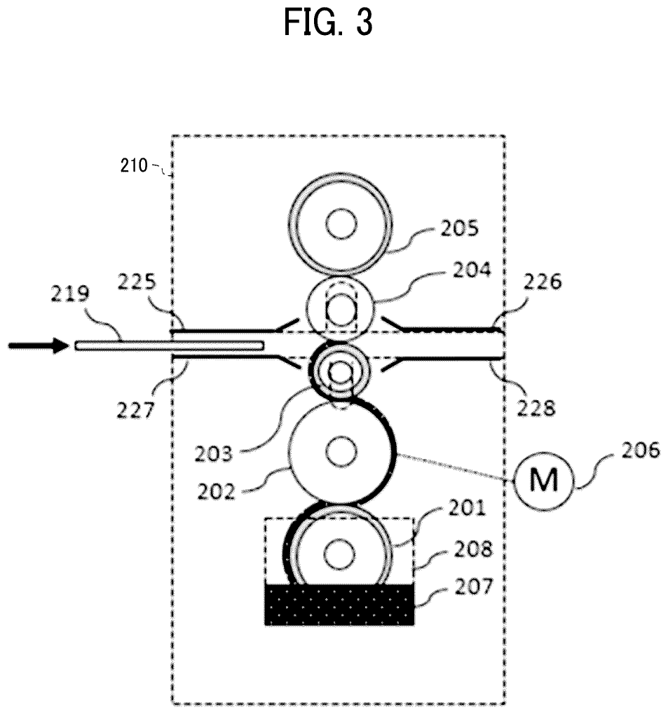

Next, a configuration of the liquid coating unit 210 as a coating module will be described with reference to the schematic view of FIG. 3. As illustrated in FIG. 3, the liquid coating unit 210 includes multiple roller-type members. The liquid coating unit 210 draws the treatment liquid 207 from the liquid supply pan 208 with a combination among these roller-type members to coat the conveyed sheet 219 with the treatment liquid 207.

The roller-type members are each rotatably held in the housing of the treatment liquid coater 200. The respective rotational shafts of the roller-type members are substantially parallel in the axial direction. That is, the multiple roller-type members is held in parallel to each other in the housing of the treatment liquid coater 200.

The liquid coating unit 210 includes the drawing roller 201 as a third roller-type member, a measuring roller 202 as a fourth roller-type member, the coating roller 203 as a first roller-type member, a pressure roller 204 as a second roller-type member, and a press roller 205 as a fifth roller-type member.

The coating roller 203 and the pressure roller 204 are each a small-diameter roller for prevention of “winding jam” that is likely to occur when the sheet 219 is thin. Further, the coating roller 203 and the pressure roller 204 are each made of a rubber material or have a surface that is coated.

The coating roller 203 and the pressure roller 204 are interposed between the measuring roller 202 and the press roller 205 so as to nip the sheet 219 at a nip between the coating roller 203 and the pressure roller 204. The measuring roller 202 and the press roller 205 are each a high-rigidity roller. The drawing roller 201 is held by the liquid supply pan 208 with the inside thereof filled with the treatment liquid 207.

The roller-type members are held in contact with the roller-type members disposed adjacent to each other. The roller-type members rotate simultaneously by driving of the roller drive motor 206. The treatment liquid 207 drawn resulting from the rotation of the drawing roller 201 is transferred to the surface of the coating roller 203 through the measuring roller 202.

An inlet upper guide 225, an outlet upper guide 226, an inlet lower guide 227, and an outlet lower guide 228 constituting part of a conveyance path for the sheet 219 are disposed between the coating roller 203 and the pressure roller 204.

The sheet 219 is conveyed in the gap between the inlet upper guide 225 and the inlet lower guide 227 and passes the nip between the coating roller 203 and the pressure roller 204. Then, the sheet 219 passes the gap between the outlet upper guide 226 and the outlet lower guide 228 disposed downstream of the nip in the conveyance direction, and is conveyed further downstream. In passing of the sheet 219 through the nip, one face of the sheet 219 is brought into pressure contact with the surface of the coating roller 203 holding the treatment liquid 207. As a result, the one face of the sheet 219 is coated with the treatment liquid 207 such that the treatment liquid 207 is transferred to the one face of the sheet 219.

### Embodiment of Module Sliding Mechanism

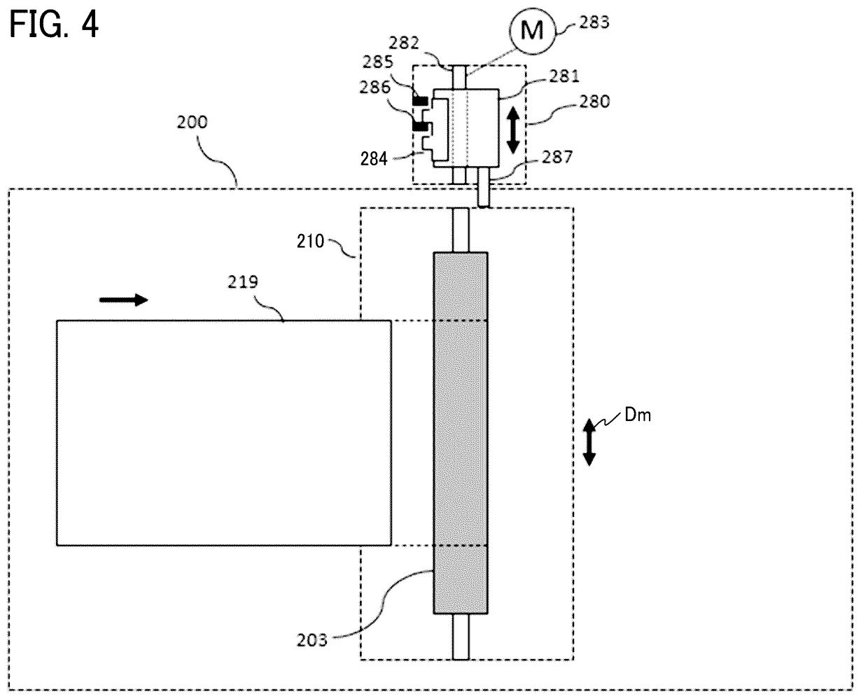

Next, the overview of a movement module 280 including an embodiment of a module sliding mechanism included in the liquid coater according to the present disclosure will be described with reference to FIG. 4. The movement module 280 has a function of moving the liquid coating unit 210 in a predetermined direction. Moving the liquid coating unit 210 by the movement module 280 results in suppression of wear of a specific part of the roller-type member that may occur in coating the sheet 219 with the treatment liquid 207 by the liquid coating unit 210. As illustrated in FIG. 4, the movement direction Dm of the liquid coating unit 210 by the movement module 280 is a direction crossing the conveyance direction of the sheet 219. This direction corresponds to the width direction of the sheet 219. That is, the movement module 280 is a mechanism that moves the liquid coating unit 210 in the width direction of the sheet 219. The movement module 280 is an example of a driver to move the moving the liquid coating unit 210 in the width direction parallel to the movement direction Dm as illustrated in FIG. 4.

The movement module 280 reciprocates the roller-type member in the width direction of the sheet 219. This reciprocating movement causes the roller-type member to move to a position where the roller-type member comes into contact with the sheet 219 in order to coat the sheet 219 with the treatment liquid 207 (see FIG. 3).

As illustrated in FIG. 4, the movement module 280 includes at least a slider 281 as an exemplary module sliding mechanism, a worm 282, a worm drive motor 283, a sensor feeler 284, a rear sensor 285 as a first sensor, a front sensor 286 as a second sensor, and a coupling member 287.

The worm 282 is secured to the frame of the movement module 280 and is rotated by the worm drive motor 283.

The slider 281 is coupled to the worm 282, and moves in the movement direction Dm as the width direction of the sheet 219 by the rotation of the worm 282.

The slider 281 and the liquid coating unit 210 are coupled through the coupling member 287.

The liquid coating unit 210 is housed in the treatment liquid coater 200, but is held so as to have a degree of freedom in the width direction of the sheet 219 (medium width direction). Thus, the liquid coating unit 210 can be moved by the movement module 280 following the movement of the slider 281.

As in the above embodiment, with the liquid coating unit 210 including such a roller-type member as described above for conveying the sheet 219, the movement module 280 can suppress wear of the roller-type member. Alternatively, the liquid coating unit 210 may include a belt-type member for conveying the sheet 219. In this case, the movement module 280 can also suppress wear of the belt-type member. In a case where the movement module 280 includes such a belt-type member, the belt-type member may have a function of cooling a medium.

### Positional Detection Mechanism of Slider

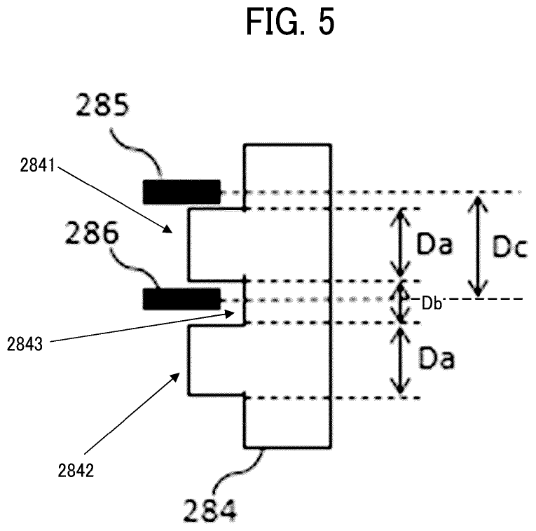

Next, a positional detection mechanism of the slider 281 that holds the liquid coating unit 210 so as to be movable in the width direction of the sheet 219 will be described with reference to FIG. 5. FIG. 5 exemplifies a relationship between the sensor feeler 284 included in the movement module 280, and the rear sensor 285 as the first sensor and the front sensor 286 as the second sensor disposed so as to be detectable of the position of the sensor feeler 284.

As described above, the sensor feeler 284 is attached to the slider 281. Therefore, the sliding direction of the sensor feeler 284 is the same as the sliding direction of the slider 281. That is, determination of the position of the sensor feeler 284 results in determination of the position of the slider 281.

The sensor feeler 284 is a member substantially rectangular in a plan view and having a longitudinal direction in the movement direction of the slider 281. In the rectangular shape, the sensor feeler 284 has a long side (end extending in the movement direction) with an uneven shape.

As illustrated in FIG. 5, the uneven shape of the sensor feeler 284 has two protrusions (a first protrusion 2841 and a second protrusion 2842) in the movement direction of the sensor feeler 284 similar to the movement direction of the slider 281, and a recess 2843 provided between the first protrusion 2841 and the second protrusion 2842.

Due to the movement of the slider 281, multiple feeler sensors attached to the frame of the movement module 280 senses the first protrusion 2841 and the second protrusion 2842 that move in the width direction of the sheet 219 (medium width direction). Two feeler sensors according to the present disclosure correspond one-to-one to the rear sensor 285 as an exemplary first feeler sensor and the front sensor 286 as an exemplary second feeler sensor. The CPU 271 determines a combination of a first sensor output as a sensor output from the rear sensor 285 and a second sensor output as a sensor output from the front sensor 286, so that the position of the sensor feeler 284 can be determined.

That is, the combination of the sensor output from the rear sensor 285 and the sensor output from the front sensor 286 varies in accordance with the positional relationship between the sensor feeler 284, and the rear sensor 285 and the front sensor 286. The timing of the variation in the combination of the sensor outputs (the timing at which the combination is switched) is determined, so that the current position of the slider 281 can be determined.

Next, the dimensional relationship in the movement direction of the first protrusion 2841, the second protrusion 2842, and the recess 2843 of the sensor feeler 284 will be described. As illustrated in FIG. 5, the dispositional interval (width) of the first protrusion 2841 and the second protrusion 2842 in the sliding direction is defined as “Da”. The width of the recess 2843 in the sliding direction is defined as “Db”. The dispositional interval between the rear sensor 285 and the front sensor 286 at which the sensor feeler 284 is sensible is defined as “Dc”.

The movement module 280 according to the present disclosure holds the sensor feeler 284, the rear sensor 285, and the front sensor 286 such that the following magnitude relationships are satisfied: Da<Dc, Db<Dc, and Dc<Da+Db.

### Positional Detection Pattern of Slider

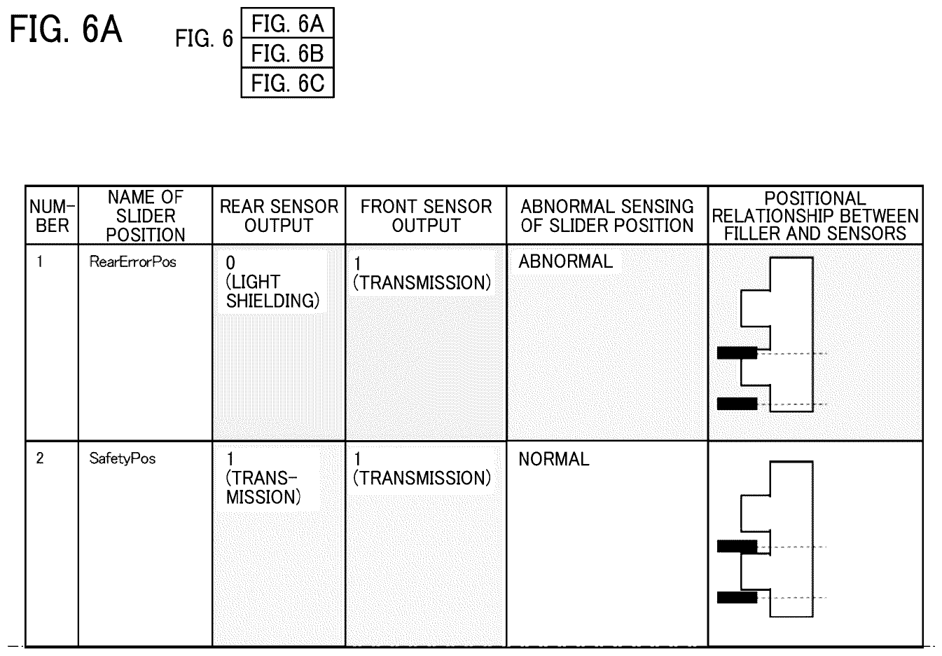

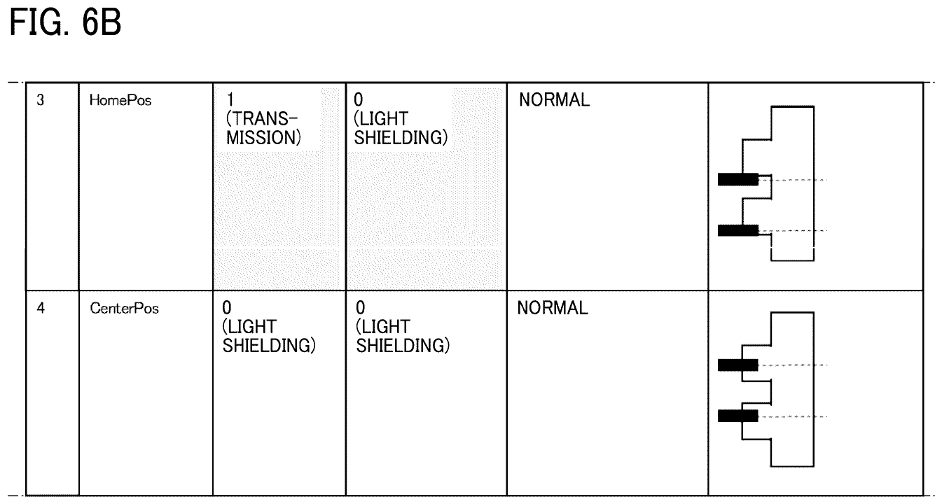

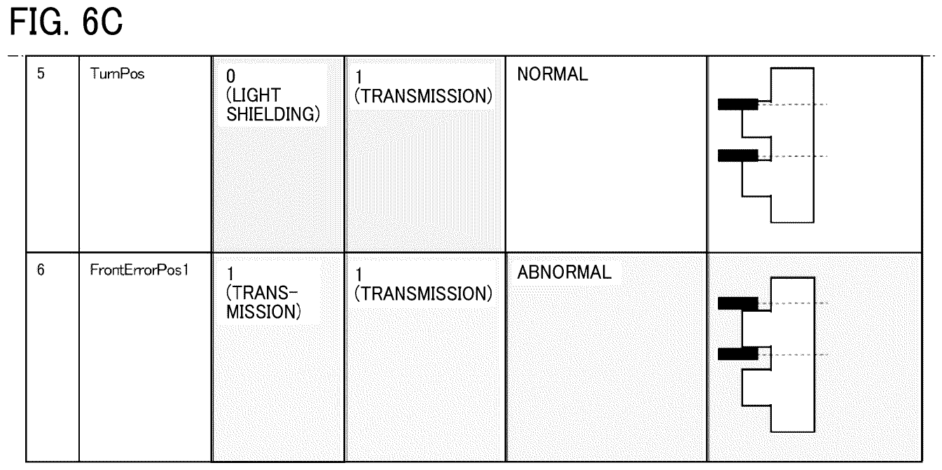

Next, the relationship between the position of the sensor feeler 284 (the position of the slider 281) disposed with the above relationships and the sensor output patterns of the rear sensor 285 and the front sensor 286 will be described with reference to FIG. 6.

As already described with reference to FIG. 5, in order to be detectable of the position of the sensor feeler 284, the rear sensor 285 and the front sensor 286 are disposed such that the positional relationship with the uneven shape of the sensor feeler 284 is a specific positional relationship. Within the range of the normal position of the sensor feeler 284, there are four combinations of sensor outputs from the rear sensor 285 and the front sensor 286 having detected the first protrusion 2841 and the second protrusion 2842. Therefore, the CPU 271 determines the timing at which switching is made among the combinations of the sensor outputs, so that the positional relationship between the sensor feeler 284, and the rear sensor 285 and the front sensor 286 can be specified.

As a result, the controller 270 can control the position of the liquid coating unit 210 on the basis of the position of the slider 281.

FIG. 6 is a table that classifies the distinction (name) of the position of the slider 281, the combination of the sensor outputs, and the abnormality detection of the slider position corresponding to the positional relationship between the sensor feeler 284 and each sensor.

For example, when the sensor output from the rear sensor 285 indicates “transmission” due to the absence of the sensor feeler 284 at the position of the rear sensor 285, and when the sensor output from the front sensor 286 indicates “light shielding” due to the presence of the sensor feeler 284 at the position of the front sensor 286, the distinction (name) of the position of the slider 281 is defined as “HomePos”. When the sensor output from the rear sensor 285 indicates “light shielding” due to the presence of the sensor feeler 284 at the position of the rear sensor 285, and when the sensor output from the front sensor 286 indicates “light shielding” due to the presence of the sensor feeler 284 at the position of the front sensor 286, the distinction (name) of the position of the slider 281 is defined as “CenterPos”.

For example, when the sensor output from the rear sensor 285 indicates “light shielding” due to the presence of the sensor feeler 284 at the position of the rear sensor 285, and when the sensor output from the front sensor 286 indicates “transmission” due to the absence of the sensor feeler 284 at the position of the front sensor 286, the distinction (name) of the position of the slider 281 is defined as “TurnPos”. When the sensor output from the rear sensor 285 indicates “transmission” due to the absence of the sensor feeler 284 at the position of the rear sensor 285, and when the sensor output from the front sensor 286 indicates “transmission” due to the absence of the sensor feeler 284 at the position of the front sensor 286, the distinction (name) is defined as “SafetyPos”.

Hereinafter, the combination of the sensor outputs from the rear sensor 285 and the front sensor 286 is expressed as “the sensor output from the rear sensor 285/the sensor output from the front sensor 286”. The sensor output indicating transmission due to the absence of the sensor feeler 284 corresponds to OFF, and thus is denoted by “0”. The sensor output indicating light shielding due to the presence of the sensor feeler 284 corresponds to ON, and thus is denoted by “1”.

In order to move the position of the liquid coating unit 210 from “HomePos” to “CenterPos”, the worm drive motor 283 may be driven to move the sensor feeler 284 in the front direction until the sensor outputs are switched from “1/0” to “0/0”.

In order to reciprocate the liquid coating unit 210 once in the medium width direction, the position of the slider 281 (hereinafter, it may be referred to as a “slider position”) may be controlled as follows. The reciprocation of the slider 281 may be repeatedly controlled while the sheet 219 is subjected to image forming processing, thereby wear of a specific part of the roller-type member due to contact with the sheet 219 may be suppressed.

If the initial position of the slider 281 is detected before the reciprocating operation of the slider 281, the reciprocating operation of the slider 281 can be appropriately started even from the halfway position in the reciprocating cycle.

The transition of the slider position for one reciprocation is as follows: “HomePos”→“CenterPos”→“TurnPos”→“CenterPos”→“HomePos”→“SafetyPos”→“HomePos”.

As described above, there are four combinations in which the two sensor outputs are the same with the slider 281 located within the range of the normal operation (normal position). However, in a case where the slider 281 has been moved to a position out of the range of the normal operation due to some abnormality (abnormal position) is included, there are seven combinations of the sensor outputs corresponding to the actual slider position.

As an abnormal position where both the sensor outputs from the rear sensor 285 and the front sensor 286 are “1” (transmission), there is also a case where the second protrusion 2842 of the sensor feeler 284 is located outside the rear sensor 285. However, due to the restriction of the movable range of the slider 281 by the frame, the movement module 280 cannot move to such an abnormal position where both the sensor outputs from the rear sensor 285 and the front sensor 286 is “1” (transmission). Thus, such a situation is not given in the following description.

Because of difficulty in distinction between the abnormal position and the normal position, it is determined as the normal position even when the slider 281 is at the abnormal position due to an assembly error or a sensor failure. As a result, image formation is likely to be started even with the slider 281 located at the abnormal position. In order to detect the abnormal position, the slider position is moved sequentially, the time until the sensor outputs from the rear sensor 285 and the front sensor 286 are switched is measured actually, and the actual measurement time is compared with the time during the normal operation.

The time during the normal operation can be calculated on the basis of, for example, the gear ratio of the worm 282 or the rotational speed setting of the worm drive motor 283.

For example, the sensor switching time is distinguished as follows. The first actual measurement time T1 for sensor switching is defined as “SafetyPos” (sensor outputs: 1/1)→“HomePos” (sensor outputs: 1/0).

The second actual measurement time T2 for sensor switching is defined as “HomePos” (sensor outputs: 1/0)→“CenterPos” (sensor outputs: 0/0).

The third actual measurement time T3 for sensor switching is defined as “CenterPos” (sensor outputs: 0/0)→“TurnPos” (sensor outputs: 0/1).

For example, the sensor outputs from the rear sensor 285 and the front sensor 286 indicating “RearErrorPos” or “TurnPos” are both “0/1”. That is, the slider position including the abnormal position cannot be distinguished only with the sensor outputs.

Therefore, as an initial operation before the start of image forming operation, an operation of reciprocating the slider 281 once is performed to detect the current position. At this time, if the third actual measurement time T3 for sensor switching is different from the normal operation time, the current position of the slider 281 can be determined as the abnormal position.

Because the abnormal position at which the sensor outputs are “0/1” is “RearErrorPos”, it can be seen that the slider 281 is at a position that the slider has moved too far to the rear side. Thereafter, as a return operation, the slider 281 is moved to the front side and moved to “SafetyPos” as the normal position.

### Amount of Slider Movement

In the configuration described with reference to FIG. 6, the amount of movement D of the slider 281 in movement direction Dm corresponds to “amount of movement D=2 Da+Db”.

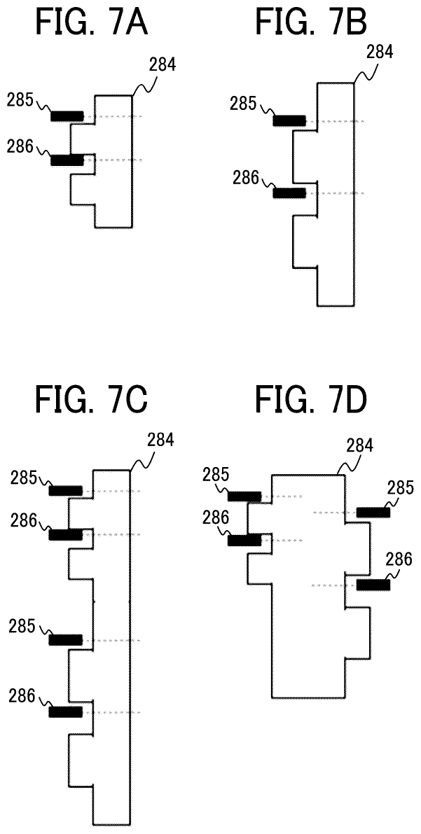

As illustrated in FIGS. 7A to 7D, various component shapes can be assumed for the sensor feeler 284. As illustrated in FIG. 7A to 7D, Da and Db that have been already described are determined in accordance with the component shape of the sensor feeler 284. Therefore, in order to change the amount of movement D of the slider 281 in the medium width direction, for example, the sensor feeler 284 may be replaced such that, for example, the shape of the sensor feeler 284 is changed.

Alternatively, in order to set multiple amounts of movement D without replacing the sensor feeler 284, as illustrated in FIGS. 7C and 7D, the number and position of protrusions and recesses that the sensor feeler 284 is provided with and the number of sensors may be increased so as to correspond to the number and position of protrusions and recesses.

FIG. 7A is an example of the configuration that has been already described in which the amount of movement D in the medium width direction is a normal amount.

FIG. 7B is an exemplary configuration in which the amount of movement D in the medium width direction is increased in comparison with the normal amount in FIG. 7A.

FIG. 7C is an exemplary configuration in which the increased amount of movement D1 is detectable with the single sensor feeler 284 in addition to the normal amount of movement D, as a configuration in which four protrusions and two recesses are provided on one side in the longitudinal direction of the sensor feeler 284 and multiple thresholds for determining the amount of movement D can be distinguished.

FIG. 7D is an exemplary configuration in which two protrusions and a recess are provided on one side and two protrusions and a recess are provided on the other side in longitudinal direction of the sensor feeler 284 such that the normal amount of movement D and the increased amount of movement D1 are detectable with the single sensor feeler 284.

In the configurations of FIG. 7D, a rear sensor 285 and a front sensor 286 are disposed left and a rear sensor 285 and a front sensor 286 are disposed right. Control is performed in accordance with the mount of movement desired to be used to make a switch among the rear sensors 285 and the front sensors 286 to be used.

As described above, the movement module 280 according to the present disclosure, with a simple configuration of the liquid coating unit 210 provided in part of the conveyance path through which the sheet 219 as a sheet-like medium (medium) is conveyed, the positional detection and return from the abnormal position of an object that is worn can be made.

A liquid coater includes: a coater to contact with a medium and coat, with a liquid, the medium conveyed to the coater in a conveyance direction; and a driver, to move the coater in a width direction intersecting the conveyance direction, the driver including: a slider slidable with the coater in the width direction; and a sensor feeler slidable with the slider in the width direction and including: two or more protrusions along the width direction; and a recess between the two or more protrusions in the width direction; and multiple feeler sensors arranged in the width direction and including: a first feeler sensor; and a second feeler sensor, separated from the first feeler sensor in the width direction, to detect the two or more protrusions and the recess of the sensor feeler; and circuitry configured to control a movement of the coater based on a combination of: a first sensor output that is an output from the first feeler sensor in response to a detection of the sensor feeler; and a second sensor output that is an output from the second feeler sensor in response to a detection of the sensor feeler.

Following relationships are satisfied: Da<Dc, Db<Dc, and Dc<Da+Db, where Da is a first interval between the two or more protrusions, Db is a width of the recess, and Dc is a second interval between the first feeler sensor and the second feeler sensor of the multiple feeler sensors.

The coater includes: a first roller to coat the medium with the liquid; and a second roller facing the first roller to from a nip between the first roller and the second roller to nip the medium, the first roller has a surface made of a rubber material or has a coated surface.

The second roller has: a surface made of a rubber material; or a coated surface.

The circuitry is further configured to: perform an initial operation to detect a current position of the slider; determine whether the current position of the slider is an abnormal position based on the initial operation based on the combination of the first sensor output and the second sensor output; and perform a return operation to return the slider to a normal position in response to a determination that the slider is at the abnormal position.

In the initial operation, the circuitry is further configured to: sequentially move the slider in one reciprocating movement; measures a switching time until the first sensor output and the second sensor output are switched; and compare the switching time with a switching time during a normal operation to detect that the slider is at the abnormal position.

The two or more protrusions has (2×n) number of protrusions, on one side of the sensor feeler in the conveyance direction, along the width direction, where n is a natural number, and a number of the multiple feeler sensors is identical to the (2×n) number of protrusions.

The two or more protrusions has (2×n) number of protrusions, on both sides of the sensor feeler in the conveyance direction, along the width direction, where n is a natural number, and a number of the multiple feeler sensors is identical to (2×n)×2 number of the two or more protrusions.

The coater includes a belt in contact with the medium to fix the liquid onto the medium.

The coater includes a belt in contact with the medium to fix the liquid onto the medium, and the belt includes a cooler to cool the medium.

A coating method includes contacting with a medium and coating the medium, conveyed in a conveyance direction, with liquid with a coater; moving the coater in a width direction intersecting the conveyance direction; moving a sensor feeler together with the coater in the width direction; detecting a position of the sensor feeler at multiple positions; and controlling a position of the coater in the width direction based on the position of the sensor feeler detected at multiple positions.

An image forming system includes: the liquid coater to coat the medium with a first liquid; and a liquid discharge apparatus to discharge a second liquid onto the medium coated with the first liquid to form an image on the medium.

The present disclosure is not limited to the specific embodiments described above, and numerous additional modifications and variations are possible in light of the teachings within the technical scope of the appended claims. It is therefore to be understood that the embodiments of this patent specification may be practiced otherwise by those skilled in the art than as specifically described herein, and such modifications and variations are within the technical scope of the appended claims. Such modifications and variations thereof are included in the scope and gist of the embodiments of the present disclosure and are included in the embodiments described in claims and the equivalent scope thereof.

According to the present disclosure, with a simple configuration, the positional detection and the return from the abnormal position of an object that is worn can be made.

The details of the present disclosure are, for example, as follows.

### Aspect 1

According to Aspect 1, a liquid coater includes: a coating module that coats a medium with liquid while being in contact with the medium; and a movement module that allows the coating module to move in a direction crossing a movement direction of the medium to the coating module, in which the movement module includes: a module sliding mechanism that allows the coating module to move by sliding in the direction crossing the movement direction; a sensor feeler that slides in a direction identical to a sliding direction of the module sliding mechanism, the sensor feeler including a protrusion including two protrusions disposed along the sliding direction and a single recess located between the two protrusions; and multiple feeler sensors disposed such that the sensor feeler is sensible, the multiple feeler sensors including a first feeler sensor and a second feeler sensor, when a disposition interval between the two protrusions, a width of the recess, and a disposition interval between the first feeler sensor and the second feeler sensor included in the multiple feeler sensors are, respectively, Da, Db, and Dc, following relationships are satisfied: Da<Dc, Db<Dc, and Dc<Da+Db, and the movement module controls the sliding direction based on a combination of a first sensor output from the first feeler sensor having sensed the sensor feeler and a second sensor output from the second feeler sensor having sensed the sensor feeler.

### Aspect 2

According to Aspect 2, in the liquid coater of Aspect 1, the coating module includes a roller-type member including a first roller-type member and a second roller-type member that are disposed in a multistage state such that a nip is formed between the first roller-type member and the second roller-type member, the first roller-type member coats the medium with the liquid, the first roller-type member has a surface that includes a rubber material or is coated, and the first roller-type member and the second roller-type member nip the medium at the nip.

### Aspect 3

According to Aspect 3, in the liquid coater of Aspect 1 or 2, the second roller-type member has a surface that includes a rubber material or is coated.

### Aspect 4

According to Aspect 4, in the liquid coater of any one of Aspects 1 to 3, based on the combination of the first sensor output and the second sensor output, the movement module controls an initial operation to detect a current position of the module sliding mechanism and controls, in accordance with a determination that the current position of the module sliding mechanism is an abnormal position due to the initial operation, a return operation to return the module sliding mechanism to a normal position.

### Aspect 5

According to Aspect 5, in the liquid coater of any one of Aspects 1 to 4, the sensor feeler has a side including (2×n) number of protrusions along the sliding direction, the n being a natural number, the protrusion of the sensor feeler includes the (2×n) number of protrusions, and a number of the multiple feeler sensors disposed is identical in number to the (2×n) number of protrusions included in the protrusion of the sensor feeler.

### Aspect 6

According to Aspect 6, in the liquid coater of any one of Aspects 1 to 4, the sensor feeler has a side and another side opposed to each other, the side including (2×n) number of protrusions along the sliding direction, the another side including (2×n) number of protrusions along the sliding direction, the n being a natural number, the protrusion of the sensor feeler includes the (2×n) number of protrusions of the side and the (2×n) number of protrusions of the another side, and a number of the multiple feeler sensors disposed is identical to a total number resulting from addition of the (2×n) number of protrusions of the side and the (2×n) number of protrusions of the another side.

### Aspect 7

According to Aspect 7, in the liquid coater of Aspect 1 or any one of Aspects 3 to 6, the coating module includes a belt-type member that fixes the liquid to the medium while being in contact with the medium.

### Aspect 8

According to Aspect 8, in the liquid coater of Aspect 1 or any one of Aspects 3 to 6, the coating module includes a belt-type member that fixes the liquid to the medium while being in contact with the medium, the belt-type member having a function of cooling the medium.

### Aspect 9

According to Aspect 9, provided is a method of controlling a liquid coater including: a coating module that coats a medium with liquid while being in contact with the medium; and a movement module that allows the coating module to move in a direction crossing a movement direction of the medium to the coating module, in which the movement module includes: a module sliding mechanism that allows the coating module to move by sliding in the direction crossing the movement direction; a sensor feeler that slides in a direction identical to a sliding direction of the module sliding mechanism, the sensor feeler including a protrusion including two protrusions disposed along the sliding direction and a single recess located between the two protrusions; and multiple feeler sensors disposed such that the sensor feeler is sensible, the multiple feeler sensors including a first feeler sensor and a second feeler sensor, when a disposition interval between the two protrusions, a width of the recess, and a disposition interval between the first feeler sensor and the second feeler sensor included in the multiple feeler sensors are, respectively, Da, Db, and Dc, following relationships are satisfied: Da<Dc, Db<Dc, and Dc<Da+Db, the method including controlling the sliding direction based on a combination of a first sensor output from the first feeler sensor having sensed the sensor feeler and a second sensor output from the second feeler sensor having sensed the sensor feeler.

### Aspect 10

According to Aspect 10, an image forming system includes: a liquid discharge apparatus that coats a medium with liquid while being in contact with the medium; and an image forming apparatus that forms an image onto the medium coated with the liquid, in which the liquid discharge apparatus includes the liquid coater according to any one of Aspects 1 to 8.

The functionality of the elements such as the controller 270 disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A liquid coater comprising:
a coater to contact with a medium and coat, with a liquid, the medium conveyed to the coater in a conveyance direction; and
a driver, to move the coater in a width direction intersecting the conveyance direction, the driver including:
a slider slidable with the coater in the width direction; and
a sensor feeler slidable with the slider in the width direction and including:
two or more protrusions along the width direction; and
a recess between the two or more protrusions in the width direction; and
multiple feeler sensors arranged in the width direction and including:
a first feeler sensor; and
a second feeler sensor, separated from the first feeler sensor in the width direction,
to detect the two or more protrusions and the recess of the sensor feeler; and
circuitry configured to control a movement of the coater based on a combination of:
a first sensor output that is an output from the first feeler sensor in response to a detection of the sensor feeler; and
a second sensor output that is an output from the second feeler sensor in response to a detection of the sensor feeler.

2. The liquid coater according to claim 1,
wherein following relationships are satisfied:
Da<Dc,
Db<Dc, and
Dc<Da+Db,
where Da is a first interval between the two or more protrusions,
Db is a width of the recess, and
Dc is a second interval between the first feeler sensor and the second feeler sensor of the multiple feeler sensors.

3. The liquid coater according to claim 1,
wherein the coater includes:
a first roller to coat the medium with the liquid; and
a second roller facing the first roller to from a nip between the first roller and the second roller to nip the medium,
the first roller has a surface made of a rubber material or has a coated surface.

4. The liquid coater according to claim 3,
wherein the second roller has:
a surface made of a rubber material; or
a coated surface.

5. The liquid coater according to claim 1,
wherein the circuitry is further configured to:
perform an initial operation to detect a current position of the slider;
determine whether the current position of the slider is an abnormal position based on the initial operation based on the combination of the first sensor output and the second sensor output; and
perform a return operation to return the slider to a normal position in response to a determination that the slider is at the abnormal position.

6. The liquid coater according to claim 5,
wherein, in the initial operation, the circuitry is further configured to:
sequentially move the slider in one reciprocating movement;
measures a switching time until the first sensor output and the second sensor output are switched; and
compare the switching time with a switching time during a normal operation to detect that the slider is at the abnormal position.

7. The liquid coater according to claim 1,
wherein the two or more protrusions has (2×n) number of protrusions, on one side of the sensor feeler in the conveyance direction, along the width direction,
where n is a natural number, and
a number of the multiple feeler sensors is identical to the (2×n) number of protrusions.

8. The liquid coater according to claim 1,
wherein the two or more protrusions has (2×n) number of protrusions, on both sides of the sensor feeler in the conveyance direction, along the width direction,
where n is a natural number, and
a number of the multiple feeler sensors is identical to (2×n)×2 number of the two or more protrusions.

9. The liquid coater according to claim 1,
wherein the coater includes a belt in contact with the medium to fix the liquid onto the medium.

10. The liquid coater according to claim 1,
wherein the coater includes a belt in contact with the medium to fix the liquid onto the medium, and
the belt includes a cooler to cool the medium.

11. A coating method comprising:
contacting with a medium and coating the medium, conveyed in a conveyance direction, with liquid with a coater;
moving the coater in a width direction intersecting the conveyance direction;
moving a sensor feeler together with the coater in the width direction;
detecting a position of the sensor feeler at multiple positions; and
controlling a position of the coater in the width direction based on the position of the sensor feeler detected at multiple positions.

12. An image forming system comprising:
the liquid coater according to claim 1 to coat the medium with a first liquid; and
a liquid discharge apparatus to discharge a second liquid onto the medium coated with the first liquid to form an image on the medium.
